(19) United States
(12) Patent Application Publication
(10) Pub. No.: US 2026/0338616 A1
(43) Pub. Date: Oct. 29, 2026

(54) DEVICES, SYSTEMS, AND METHODS FOR TEMPERATURE SENSING

(71) Applicant: STMicroelectronics International N.V., Geneva (CH)

(72) Inventors: Xiaoxian LI, Shanghai (CN); Ruifeng PAN, Beijing (CN); Yuping SHU, Shanghai (CN)

(21) Appl. No.: 19/190,092

(22) Filed: Apr. 25, 2025

(51) Int. Cl. G01K 7/24

(52) U.S. Cl. CPC G01K 7/24; G01K 2219/00

(57) ABSTRACT

In accordance with various embodiments of the present disclosure, a temperature sensing method is provided. In some embodiments, the method comprises: arranging a plurality of resistive temperature sensors (RTSs) in equal size groups; connecting a first end of each RTS in a same group to a respective first node; connecting a first end of each of a plurality of fixed resistors to a supply voltage and a second end of each resistor to the first node of a respective group of RTSs; connecting the first end of each of a group of diodes to a respective RTS; connecting the second end of each diode to the second end of one respective diode in each other group of diodes via a respective second node; connecting each of the first nodes to a respective first input and each of the second nodes to a respective second input of a device.

### FIELD OF THE INVENTION

Example embodiments of the present disclosure relate generally to temperature sensing and, more particularly, to temperature sensing using a plurality of resistive temperature sensors.

### BACKGROUND

A battery energy storage system is a type of energy storage technology that uses a group of batteries to store electrical energy. Battery energy storage systems can provide a quickly dispatchable source of power on electric grids and are used to stabilize those grids, as battery energy storage systems can transition from standby to full power in under a second to deal with grid contingencies.

Battery energy storage systems typically comprise a number of battery packs, and each battery pack typically comprises a number of battery cells. Battery monitoring systems (BMSs) are used to monitor several variables of the battery cells, such as voltage, current, and temperature. Temperature monitoring can help prevent fires by shutting down the battery cell if the temperature rises above a predetermined threshold.

Temperature sensors adjacent to the battery cells are used to monitor temperatures. Resistive type temperature sensors, such as negative-temperature-coefficient (NTC) or positive-temperature-coefficient (PTC) sensors are typically used. Such NTC and PTC sensors are also called NTC and PTC thermistors. With NTC sensors, resistance decreases as temperature rises, while, with PTC sensors, resistance increases as temperature rises. The change in resistance can be measured (directly or indirectly) to determine the temperature of the battery cell.

In one example approach that has been used before, one temperature sensor is used to monitor two battery cells. The temperature sensors are typically connected to a BMS analog front end (AFE), which typically includes multiple analog-to-digital converter (ADC) inputs to convert the analog signal from the temperature sensor to digital such that the BMS AFE can provide those digital values to a BMS microcontroller (MCU).

Safety standards in some countries require one temperature sensor for each battery cell, rather than a shared configuration. The challenge with having one temperature sensor for each battery cell is that the BMS AFE often does not have enough ADC inputs to interface with such a large number of temperature sensors. To address this problem, it is known to use analog multiplexers to increase the number of temperature sensors that can be interfaced to a BMS AFE with insufficient ADC inputs. In some approaches, multiple chained analog multiplexers may be used if needed. While the use of such analog multiplexers works, this configuration adds cost and complexity.

Applicant has identified many technical challenges and difficulties associated with temperature sensing using a plurality of resistive temperature sensors. Through applied effort, ingenuity, and innovation, Applicant has solved problems related to temperature sensing using a plurality of resistive temperature sensors by developing solutions embodied in the present disclosure, which are described in detail below.

### BRIEF SUMMARY

Various embodiments described herein related to devices, systems, and methods for temperature sensing using a plurality of resistive temperature sensors.

In accordance with various embodiments of the present disclosure, a temperature sensing method is provided. In some embodiments, the temperature sensing method comprises: arranging a plurality of resistive temperature sensors (RTSs) in a plurality of groups, each group comprising a same number of RTSs; positioning each RTS adjacent a structure whose temperature is to be determined; for each group of RTSs, connecting a first end of each RTS in a same group to a respective one of a plurality of first nodes; connecting a first end of each of a plurality of resistors each having a fixed resistance value to a supply voltage and a second end of each of the plurality of resistors to the first node of a respective group of RTSs; arranging a plurality of diodes in a plurality of groups, each group of diodes corresponding to a respective group of RTSs, each diode having a first end and a second end; connecting the first end of each diode to a respective RTS; connecting the second end of each diode to the second end of one respective diode in each other group of diodes via a respective one of a plurality of second nodes; connecting each of the first nodes to a respective first input of a device having a plurality of first inputs and a plurality of second inputs; and connecting each of the second nodes to a respective second input of the device; wherein a quantity of the resistors equals a quantity of the groups of the RTSs; wherein a quantity of the first nodes equals a quantity of the groups of the RTSs; wherein a quantity of the diodes equals a quantity of the RTSs; and wherein a quantity of the second nodes equal a quantity of the RTSs in each group of the RTSs.

In some embodiments, the method further comprises: (a) setting a first one of second inputs to ground and others of the second inputs to a high resistance mode such that current flows through each RTS connected via a corresponding diode to a corresponding one of the second nodes connected to the first one of the second inputs; (b) measuring a voltage at a first one of the first inputs; (c) determining a voltage drop across the resistor connected to a respective one of the first nodes that is connected to the first one of the first inputs by subtracting (i) the measured voltage at the first one of the first inputs from (ii) the supply voltage; (d) determining a current through the resistor connected to a respective one of the first nodes that is connected to the first one of the first inputs by dividing (i) the determined voltage drop across the resistor connected to a respective one of the first nodes that is connected to the first one of the first inputs by (ii) the fixed resistance value of the resistor connected to a respective one of the first nodes that is connected to the first one of the first inputs; (e) determining a voltage drop across the RTS whose first end is connected to the respective one of the first nodes that is connected to the first one of the first inputs and whose corresponding diode is connected to the corresponding one of the second nodes connected to the first one of the second inputs by subtracting (i) a voltage drop across the diode whose second end is connected to the corresponding one of the second nodes connected to the first one of the second inputs and whose first end is connected to the RTS which is connected to the one of the first nodes that is connected to the first one of the first inputs from (ii) the measured voltage at the first one of the first inputs; (f) determining a resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs by dividing the voltage drop across the RTS whose first end is connected to the respective one of the first nodes that is connected to the first one of the first inputs and whose second end is connected to a respective one of the diodes whose second end is connected to the corresponding one of the second nodes connected to the first one of the second inputs by the current through the resistor connected to a respective one of the first nodes that is connected to the first one of the first inputs, wherein the resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs correlates to a temperature measured by the RTS whose first end is connected to the respective one of the first nodes that is connected to the first one of the first inputs and whose second end is connected to a respective one of the diodes whose second end is connected to the corresponding one of the second nodes connected to the first one of the second inputs; (g) repeating (b) through (f) for each subsequent one of the first inputs; and (h) repeating (a) through (g) for each subsequent ones of the second inputs.

In some embodiments, the first end of each diode comprises an anode and the second end of each diode comprises a cathode.

In some embodiments, each of the first inputs of the device comprises an analog-to-digital controller (ADC) and each of the second inputs of the device comprises a general purpose input.

In some embodiments, each of the RTSs comprise either a negative-temperature-coefficient sensor or a positive-temperature-coefficient sensor.

In some embodiments, the device comprises an analog front end.

In some embodiments, the device comprises a microcontroller.

In accordance with various embodiments of the present disclosure, a temperature sensing device is provided. In some embodiments, the temperature sensing device comprises a plurality of first inputs and a plurality of second inputs and control circuitry. The control circuitry is adapted to determine a resistance of each of a plurality of resistive temperature sensors (RTSs) electrically connected in a matrix of N x M RTSs, each RTS connected in series with a respective diode. Each group of N RTSs is connected to a respective one of the first inputs via a first end of each respective RTS connected to a respective first node. Each group of M RTSs is connected to a respective one of the second inputs via a second end of each respective diode connected to a respective second node. A first end of each of a plurality of resistors each having a fixed resistance value is connected to a supply voltage and a second end of each of the plurality of resistors is connected to the first node of a respective group of N RTSs. The control circuitry is configured to: (a) set a first one of the second inputs to ground and others of the second inputs to a high resistance mode such that current flows through each RTS and corresponding diode connected to the one of the second nodes that is connected to the first one of the second inputs; (b) measure a voltage at a first one of the first inputs; (c) determine a voltage drop across the resistor connected to a respective one of the first nodes that is connected to the first one of the first inputs by subtracting (i) the measured voltage at the first one of the first inputs from (ii) the supply voltage; (d) determine a current through the resistor connected to a respective one of the first nodes that is connected to the first one of the first inputs by dividing (i) the determined voltage drop across the resistor connected to a respective one of the first nodes that is connected to the first one of the first inputs by (ii) the fixed resistance value of the resistor connected to a respective one of the first nodes that is connected to the first one of the first inputs; (e) determine a voltage drop across the RTS whose first end is connected to the respective one of the first nodes that is connected to the first one of the first inputs and whose corresponding diode is connected to the corresponding one of the second nodes connected to the first one of the second inputs by subtracting (i) a voltage drop across the corresponding diode connected to the corresponding one of the second nodes connected to the first one of the second inputs from (ii) the measured voltage at the first one of the first inputs; (f) determine a resistance of the RTS whose first end is connected to the respective one of the first nodes that is connected to the first one of the first inputs and whose corresponding diode is connected to the corresponding one of the second nodes connected to the first one of the second inputs by dividing (i) the voltage drop across the RTS whose first end is connected to the respective one of the first nodes that is connected to the first one of the first inputs and whose corresponding diode is connected to the corresponding one of the second nodes connected to the first one of the second inputs by (ii) the current through the resistor connected to a respective one of the first nodes that is connected to the first one of the first inputs, wherein the resistance of the RTS whose first end is connected to the respective one of the first nodes that is connected to the first one of the first inputs and whose corresponding diode is connected to the corresponding one of the second nodes connected to the first one of the second inputs correlates to a temperature measured by the RTS whose first end is connected to the respective one of the first nodes that is connected to the first one of the first inputs and whose corresponding diode is connected to the corresponding one of the second nodes connected to the first one of the second inputs; (g) repeat (b) through (f) for each subsequent one of the first inputs; and (h) repeat (a) through (g) for each subsequent ones of the second inputs.

In accordance with various embodiments of the present disclosure, a temperature sensing system is provided. In some embodiments, the temperature sensing system comprises a plurality of resistive temperature sensors (RTSs) arranged in a plurality of groups, each group comprising a same number of RTSs, each RTS adapted to be positioned adjacent a structure whose temperature is to be determined, wherein, for each group of RTSs, a first end of each RTS in a same group is connected to a respective one of a plurality of first nodes; a plurality of resistors each having a fixed resistance value, a first end of each of the plurality of resistors is adapted to be connected to a supply voltage and a second end of each of the plurality of resistors is connected to the first node of a respective group of RTSs; a plurality of diodes arranged in a plurality of groups, each group of diodes corresponding to a respective group of RTSs, each diode having a first end and a second end, the first end of each diode being connected to a respective RTS in a respective group of RTSs, the second end of each diode beings connected to the second end of one respective diode in each other group of diodes via a respective one of a plurality of second nodes; and a device having a plurality of first inputs and a plurality of second inputs. Each of the first nodes is connected to a respective first input of the device. Each of the second nodes is connected to a respective second input of the device. A quantity of the resistors equals a quantity of the groups of the RTSs. A quantity of the first nodes equals a quantity of the groups of the RTSs. A quantity of the diodes equals a quantity of the RTSs. A quantity of the second nodes equal a quantity of the RTSs in each group of the RTSs.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 provides a block diagram of an example system for temperature sensing using a plurality of resistive temperature sensors, in accordance with some embodiments of the present disclosure; and

FIG. 2 provides an example flow diagram illustrating an example method for temperature sensing using a plurality of resistive temperature sensors, in accordance with some embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing integrated circuits, printed circuit boards (PCBs), systems, devices, and methods for interfacing multiple resistive temperature sensors (RTSs) to an integrated circuit, PCB, device, etc. having fewer inputs than would be needed to connect each temperature sensor to its own separate input. Various embodiments of the present disclosure may be implemented as a BMS AFE or MCU).

Various embodiments of the present disclosure use matrix scanning to support a quantity of ‘n’ temperature sensors with an integrated circuit, PCB, device, etc. (such as a BMS AFE or MCU) having a quantity of ‘m’ inputs, where m < n. In this regard, various embodiments of the present disclosure can monitor RTSs using fewer AFE inputs, so added multiplexers are not needed.

Various embodiments of the present disclosure may be used with battery energy storage systems, other multi-cell battery systems (e.g., electric vehicles), or other devices/systems that use multiple resistive sensors. Embodiments of the present disclosure may be used with any type of resistive sensors, such as NTC and PTC temperature sensors.

Various embodiments of the present disclosure are described herein in relation to battery management systems, however various embodiments of the present disclosure may be used with any suitable system in which the temperatures at a number of different locations/structures/etc. are monitored using a number of RTSs. Various embodiments of the present disclosure are described herein in relation to a BMS AFE, however any suitable integrated circuit, PCB, device, etc. may be used (such as a BMS MCU).

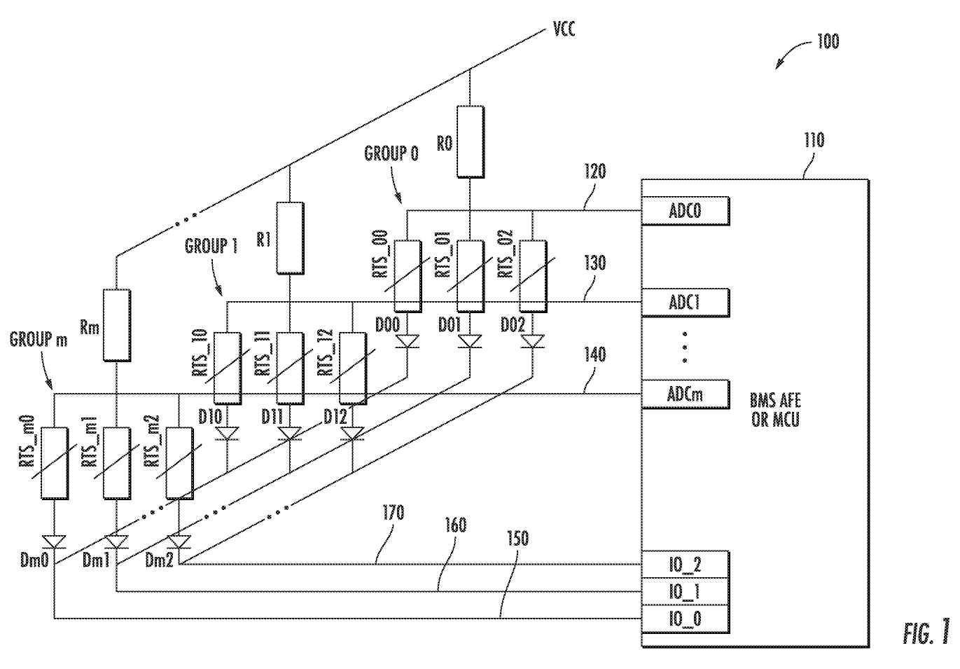

FIG. 1 provides a block diagram of an example system for temperature sensing using a plurality of resistive temperature sensors, in accordance with some embodiments of the present disclosure. The example system 100 of FIG. 1 comprises a matrix of resistive temperature sensors in groups of three, with three groups shown (but this may be more generically stated as “m” groups). These three groups are labeled group 0, group 1, and group m. The temperature sensors in group 0 are labeled RTS_00, RTS_01, and RTS_02. The temperature sensors in group 1 are labeled RTS_10, RTS_11, and RTS_12. The temperature sensors in group m are labeled RTS_m0, RTS_m1, and RTS_m2. The RTSs in FIG. 1 are shown both physically aligned and electrically connected in a matrix. While the RTSs should be electrically connected in a matrix that is the same or similar to FIG. 1, the RTSs in an actual implementation are unlikely to be physically aligned in a matrix. The physical arrangement of the RTSs will be determined by the physical arrangement of the devices/structures/etc. whose temperatures are to be monitored, as there will be an RTS positioned adjacent to each of the devices/structures/etc. whose temperatures are to be monitored.

While FIG. 1 shows three groups of three temperature sensors each, fewer or more groups may be used and/or each group may include fewer or more temperature sensors. Each group of three temperature sensors is connected to the same ADC input of a device 110, which may comprise for example a BMS AFE or MCU. The three ADC inputs are labeled as ADC0, ADC1,…ADCm, however the device may have any suitable number of ADC inputs. The AFE also has general purpose inputs. The three general purpose inputs are labeled as IO_0, IO_1, IO_2, however the device may have any suitable number of general purpose inputs.

For each group of temperature sensors connected to the same ADC input, there is a fixed value resistor. In various embodiments, any suitable resistance value may be used. In various embodiments, all of the resistors have the same fixed resistance value. In various embodiments, the values selected for resistors R0, R1, …, Rm should generally be equal to the resistance values corresponding to NTC at around 25 degrees, such as, for example, 10 kiloohm. A first end of each fixed value resistor is connected to a supply voltage and a second end of the fixed value resistor is connected to the first ends of each of the three temperature sensors in a group. Each of the three temperature sensors in a group is connected to the anode of a respective diode, while the cathode of each diode in a group is connected to a different general purpose input of the AFE. In some embodiments, the diodes may be implemented within the device 110 rather than as separate components from the device 110.

More specifically, in FIG. 1, group 0 comprises a fixed value resistor R0. The first (top) end of R0 is connected to supply voltage VCC while the second (bottom) end of R0 is connected via node 120 to the first (top) ends of each of the temperature sensors RTS_00, RTS_01, RTS_02 in group 0. The node 120 also connects the resistor R0 and the temperature sensors RTS_00, RTS_01, RTS_02 in group 0 to ADC0.

The second (bottom) end of each of the temperature sensors RTS_00, RTS_01, RTS_02 is connected to the anode of a respective diode. Specifically, temperature sensor RTS_00 is connected to the anode of diode D00, temperature sensor RTS_01 is connected to the anode of diode D01, and temperature sensor RTS_02 is connected to the anode of diode D02. The cathode of each diode D00, D01, D02 in group 0 is connected to a different general purpose input via a different node. Specifically, diode D00 is connected to general purpose input IO_0 via node 150, diode D01 is connected to general purpose input IO_1 via node 160, and diode D02 is connected to general purpose input IO_2 via node 170. In various embodiments, the diodes prevent current from flowing in reverse (bottom to top) through any of the temperature sensors.

Groups 1 and m are structured and connected the same as group 0. One diode (and therefore one temperature sensor) in each group is connected to a same one of the general purpose inputs. In this regard, a selectable matrix of temperature sensors is created as described further below.

Specifically, in FIG. 1, group 1 comprises a fixed value resistor R1. The first (top) end of R1 is connected to supply voltage VCC while the second (bottom) end of R1 is connected via node 130 to the first (top) ends of each of the temperature sensors RTS_10, RTS_11, RTS_12 in group 1. The node 130 also connects the resistor R1 and the temperature sensors RTS_10, RTS_11, RTS_12 in group 1 to ADC1.

The second (bottom) end of each of the temperature sensors RTS_10, RTS_11, RTS_12 is connected to the anode of a respective diode. Specifically, temperature sensor RTS_10 is connected to the anode of diode D10, temperature sensor RTS_11 is connected to the anode of diode D11, and temperature sensor RTS_12 is connected to the anode of diode D12. The cathode of each diode D10, D11, D12 in group 1 is connected to a different general purpose input. Specifically, diode D10 is connected to general purpose input IO_0 via node 150, diode D11 is connected to general purpose input IO_1 via node 160, and diode D12 is connected to general purpose input IO_2 via node 170.

Specifically, in FIG. 1, group m comprises a fixed value resistor Rm. The first (top) end of Rm is connected to supply voltage VCC while the second (bottom) end of Rm is connected via node 140 to the first (top) ends of each of the temperature sensors RTS_m0, RTS_m1, RTS_m2 in group m. The node 140 also connects the resistor Rm and the temperature sensors RTS_m0, RTS_m1, RTS_m2 in group m to ADCm.

The second (bottom) end of each of the temperature sensors RTS_m0, RTS_m1, RTS_m2 is connected to the anode of a respective diode. Specifically, temperature sensor RTS_m0 is connected to the anode of diode Dm0, temperature sensor RTS_m1 is connected to the anode of diode Dm1, and temperature sensor RTS_m2 is connected to the anode of diode Dm2. The cathode of each diode Dm0, Dm1, Dm2 in group m is connected to a different general purpose input. Specifically, diode Dm0 is connected to general purpose input IO_0 via node 150, diode Dm1 is connected to general purpose input IO_1 via node 160, and diode Dm2 is connected to general purpose input IO_2 via node 170.

The voltage at VCC is known (which may be, for example, 5 volts). Via the connection to ADC input ADC0, the voltage between R0 and the three temperature sensors in group 0 can be measured. Similarly, the voltage between R1 and the three temperature sensors in group 1 can be measured at input ADC1, and the voltage between Rm and the three temperature sensors in group m can be measured at input ADCm. The voltage drop across each diode is known. In operation, in turn each general purpose input is set to ground while the others are set to high resistance mode and the voltage is measured at each ADC input. This allows for the resistance of each temperature sensor to be calculated every third cycle, as described further below.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, the device 110 comprises processing circuitry to control the operation described herein. The processing circuitry may also be referred to as a central processing unit (CPU), processor, controller, or control circuitry. The processing circuity may be embodied in a number of different ways. In various embodiments, the use of the terms “processor,” “processing circuity,” “controller,” or “control circuitry” should be understood to include a single core processor, a multi-core processor, multiple processors internal to the device 110, and/or one or more remote or “cloud” processor(s) external to the device 110. In some example embodiments, the processing circuity may include one or more processing devices configured to perform independently. Alternatively, or additionally, the processing circuity may include one or more processor(s) configured in tandem via a bus to enable independent execution of operations, instructions, pipelining, and/or multithreading.

In an example embodiment, the processing circuity may be configured to execute instructions stored in memory circuitry or memory (not illustrated) or otherwise accessible to the processor. Alternatively, or additionally, the processing circuity may be configured to execute hard-coded functionality. As such, whether configured by hardware or software methods, or by a combination thereof, the processing circuity may represent an entity (e.g., physically embodied in circuitry) capable of performing operations according to embodiments of the present disclosure while configured accordingly. Alternatively, or additionally, the processing circuity may be embodied as an executor of software instructions, and the instructions may specifically configure the processing circuity to perform the various algorithms embodied in one or more operations described herein when such instructions are executed. In some embodiments, the processing circuity includes hardware, software, firmware, and/or a combination thereof that performs one or more operations described herein.

In some embodiments, the processing circuity (and/or co-processor or any other processing circuitry assisting or otherwise associated with the processor) is/are in communication with the memory circuitry via a bus for passing information among components of the device 110.

The memory or memory circuitry may be non-transitory and may include, for example, one or more volatile and/or non-volatile memories. In some embodiments, the memory circuitry includes or embodies an electronic storage device (e.g., a computer readable storage medium). In some embodiments, the memory circuitry is configured to store information, data, content, applications, instructions, or the like, for enabling a device 110 to carry out various operations and/or functions in accordance with example embodiments of the present disclosure.

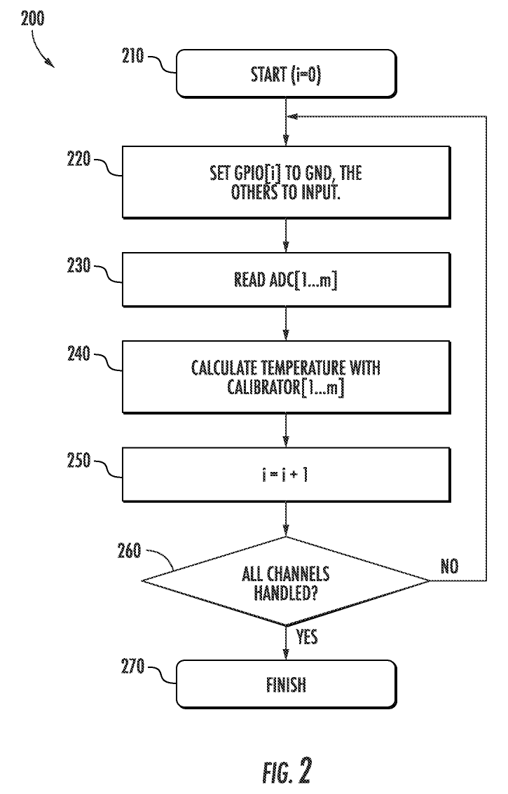

Reference will now be made to FIG. 2, which provides a flowchart illustrating example steps, processes, procedures, and/or operations in accordance with various embodiments of the present disclosure. Various methods described herein, including, for example, example methods as shown in FIG. 2, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIG. 2 may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Referring now to FIG. 2, an example flow diagram illustrating an example method 200 for temperature sensing using a plurality of resistive temperature sensors in accordance with some embodiments of the present disclosure is illustrated. In some embodiments, the example method 200 may be implemented by an example device described herein, including, but not limited to, the example device 110 described above in connection with FIG. 1.

The example method 200 shown in FIG. 2 starts at step/operation 210. At step/operation 210, a processor (such as, but not limited to, the processing circuitry of the device 110 described above in connection with FIG. 1) sets a counter “i” to zero.

At step/operation 220, a processor (such as, but not limited to, the processing circuitry of the device 110 described above in connection with FIG. 1) sets a first one of the general purpose inputs (“GPIO”) to ground (“GND”) and sets the others to high resistance mode (“INPUT”) mode. Specifically, general purpose input IO_0 is initially set to ground and IO_1 and IO_2 are set to high resistance mode. This results in current flowing from VCC to input IO_0 through (a) R0, RTS_00, and D00, (b) R1, RTS_10, and D10, and (c) Rm, RTS_m0, and Dm0.

At step/operation 230, a processor (such as, but not limited to, the processing circuitry of the device 110 described above in connection with FIG. 1) measures the voltage at each ADC input (ADC0 through ADCm).

At step/operation 240, a processor (such as, but not limited to, the processing circuitry of the device 110 described above in connection with FIG. 1) uses the voltage measured at step/operation 230 to determine the resistance and therefore the temperature at each of the RTSs connected to the general purpose input that is set to ground.

By measuring the voltage at ADC0, the voltage drop across R0 is determined (i.e., VCC minus the voltage at ADC0). By knowing the value of R0 (which is fixed), the current through R0 is calculated (i.e., voltage drop across R0 divided by value of R0). Because inputs IO_1 and IO_2 are set to high resistance mode, almost no current can flow through RTS_01 or RTS_02. Therefore, all of the current through R0 also flows through RTS_00 and diode D00. By knowing the voltage at ADC0 and the voltage drop of diode D00 (based on the specific type of diodes used), those two values are subtracted to get the voltage drop across RTS_00. The resistance of RTS_00 is then calculated by dividing the voltage drop across RTS_00 by the current through R0. The resistance of temperature sensor RTS_00 correlates to its temperature, so we can use this determined resistance to determine the temperature of temperature sensor RTS_00 and therefore the device/structure/etc. adjacent to temperature sensor RTS_00. This process in step/operation 240 is then repeated using the measured voltage (obtained at step/operation 230) at the other ADC inputs and temperature sensors RTS_10 through RTS_m0.

At step/operation 240, the resistance of RTS_10 and RTS_m0 (and any other RTSs between RTS_10 and RTS_m0 (not illustrated)) are determined the same way, using the voltage measured at each remaining ADC input at step operation 230.

At step/operation 250, a processor (such as, but not limited to, the processing circuitry of the device 110 described above in connection with FIG. 1) increments the counter by one (i = i + 1).

At step/operation 260, a processor (such as, but not limited to, the processing circuitry of the device 110 described above in connection with FIG. 1) determines if all of the general purpose inputs have been set to ground such that the voltage of all RTSs has been read and the temperature of all RTSs has been determined. If it is determined at step/operation 260 that all of the sampling groups have not been handled, the method 200 repeats steps/operations 220-260 for the next general purpose input until all of the general purpose inputs have been set to ground and the resistance and therefore temperature of the temperature sensors connected to each of the general purpose inputs set to ground are determined. If it is determined at step/operation 260 that all of the sampling groups have been handled, such that the resistance and therefore temperature of all of the temperature sensors have been determined, the method 200 proceeds to step/operation 270 and ends.

In various embodiments, the example method 200 runs continuously on the device.

In various embodiments, by continuously repeating this process of setting one of the general purpose inputs to ground and the others to high resistance mode and then measuring the voltage at each ADC input, the resistance of each of the temperature sensors and therefore the corresponding temperature at each of the temperature sensors, can be repeatedly determined, all in a few milliseconds.

Advantageously, this is done using fewer AFE inputs, so added multiplexers are not needed. For example, 18 sensors grouped in 6 groups of 3 would only need 9 inputs (6 ADC inputs and 3 general purpose inputs). As another example, 36 sensors grouped in 6 groups of 6 would only need 12 inputs (6 ADC inputs and 6 general purpose inputs). Generically, the number of groups of RTSs corresponds to the number of ADC inputs needed, and the number of sensors in each group corresponds to the number of general purpose inputs needed. The cost of the added diodes is much less than the cost of added multiplexers, so the overall cost of this solution is lower.

### Conclusion

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of system or device for monitoring a plurality of sensors, particularly temperature sensors, and more particularly resistive temperature sensors.

Within the appended claims, unless the specific term “means for” or “step for” is used within a given claim, it is not intended that the claim be interpreted under 35 U.S.C. 112, paragraph 6.

What is claimed is:

1. A temperature sensing method comprising:
arranging a plurality of resistive temperature sensors (RTSs) in a plurality of groups, each group comprising a same number of RTSs;
positioning each RTS adjacent a structure whose temperature is to be determined;
for each group of RTSs, connecting a first end of each RTS in a same group to a respective one of a plurality of first nodes;
connecting a first end of each of a plurality of resistors each having a fixed resistance value to a supply voltage and a second end of each of the plurality of resistors to the first node of a respective group of RTSs;
arranging a plurality of diodes in a plurality of groups, each group of diodes corresponding to a respective group of RTSs, each diode having a first end and a second end;
connecting the first end of each diode to a respective RTS;
connecting the second end of each diode to the second end of one respective diode in each other group of diodes via a respective one of a plurality of second nodes;
connecting each of the first nodes to a respective first input of a device having a plurality of first inputs and a plurality of second inputs; and
connecting each of the second nodes to a respective second input of the device;
wherein a quantity of the resistors equals a quantity of the groups of the RTSs;
wherein a quantity of the first nodes equals a quantity of the groups of the RTSs;
wherein a quantity of the diodes equals a quantity of the RTSs; and
wherein a quantity of the second nodes equal a quantity of the RTSs in each group of the RTSs.

2. The method of claim 1, further comprising:
(a) setting a first one of second inputs to ground and others of the second inputs to a high resistance mode such that current flows through each RTS connected via a corresponding diode to a corresponding one of the second nodes connected to the first one of the second inputs;
(b) measuring a voltage at a first one of the first inputs;
(c) determining a voltage drop across the resistor connected to a respective one of the first nodes that is connected to the first one of the first inputs by subtracting (i) the measured voltage at the first one of the first inputs from (ii) the supply voltage;
(d) determining a current through the resistor connected to a respective one of the first nodes that is connected to the first one of the first inputs by dividing (i) the determined voltage drop across the resistor connected to a respective one of the first nodes that is connected to the first one of the first inputs by (ii) the fixed resistance value of the resistor connected to a respective one of the first nodes that is connected to the first one of the first inputs;
(e) determining a voltage drop across the RTS whose first end is connected to the respective one of the first nodes that is connected to the first one of the first inputs and whose corresponding diode is connected to the corresponding one of the second nodes connected to the first one of the second inputs by subtracting (i) a voltage drop across the diode whose second end is connected to the corresponding one of the second nodes connected to the first one of the second inputs and whose first end is connected to the RTS which is connected to the one of the first nodes that is connected to the first one of the first inputs from (ii) the measured voltage at the first one of the first inputs;
(f) determining a resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs by dividing the voltage drop across the RTS whose first end is connected to the respective one of the first nodes that is connected to the first one of the first inputs and whose second end is connected to a respective one of the diodes whose second end is connected to the corresponding one of the second nodes connected to the first one of the second inputs by the current through the resistor connected to a respective one of the first nodes that is connected to the first one of the first inputs, wherein the resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs correlates to a temperature measured by the RTS whose first end is connected to the respective one of the first nodes that is connected to the first one of the first inputs and whose second end is connected to a respective one of the diodes whose second end is connected to the corresponding one of the second nodes connected to the first one of the second inputs;
(g) repeating (b) through (f) for each subsequent one of the first inputs; and
(h) repeating (a) through (g) for each subsequent ones of the second inputs.

3. The method of claim 1, wherein the first end of each diode comprises an anode and the second end of each diode comprises a cathode.

4. The method of claim 1, wherein each of the first inputs of the device comprises an analog-to-digital controller (ADC) and each of the second inputs of the device comprises a general purpose input.

5. The method of claim 1, wherein each of the RTSs comprise either a negative-temperature-coefficient sensor or a positive-temperature-coefficient sensor.

6. The method of claim 1, wherein the device comprises an analog front end.

7. The method of claim 1, wherein the device comprises a microcontroller.

8. A temperature sensing device comprising:
a plurality of first inputs and a plurality of second inputs; and
control circuitry;
wherein the control circuitry is adapted to determine a resistance of each of a plurality of resistive temperature sensors (RTSs) electrically connected in a matrix of N x M RTSs, each RTS connected in series with a respective diode;
wherein each group of N RTSs is connected to a respective one of the first inputs via a first end of each respective RTS connected to a respective first node;
wherein each group of M RTSs is connected to a respective one of the second inputs via a second end of each respective diode connected to a respective second node;
wherein a first end of each of a plurality of resistors each having a fixed resistance value is connected to a supply voltage and a second end of each of the plurality of resistors is connected to the first node of a respective group of N RTSs; and
wherein the control circuitry is configured to:
(a) set a first one of the second inputs to ground and others of the second inputs to a high resistance mode such that current flows through each RTS and corresponding diode connected to the one of the second nodes that is connected to the first one of the second inputs;
(b) measure a voltage at a first one of the first inputs;
(c) determine a voltage drop across the resistor connected to a respective one of the first nodes that is connected to the first one of the first inputs by subtracting (i) the measured voltage at the first one of the first inputs from (ii) the supply voltage;
(d) determine a current through the resistor connected to a respective one of the first nodes that is connected to the first one of the first inputs by dividing (i) the determined voltage drop across the resistor connected to a respective one of the first nodes that is connected to the first one of the first inputs by (ii) the fixed resistance value of the resistor connected to a respective one of the first nodes that is connected to the first one of the first inputs;
(e) determine a voltage drop across the RTS whose first end is connected to the respective one of the first nodes that is connected to the first one of the first inputs and whose corresponding diode is connected to the corresponding one of the second nodes connected to the first one of the second inputs by subtracting (i) a voltage drop across the corresponding diode connected to the corresponding one of the second nodes connected to the first one of the second inputs from (ii) the measured voltage at the first one of the first inputs;
(f) determine a resistance of the RTS whose first end is connected to the respective one of the first nodes that is connected to the first one of the first inputs and whose corresponding diode is connected to the corresponding one of the second nodes connected to the first one of the second inputs by dividing (i) the voltage drop across the RTS whose first end is connected to the respective one of the first nodes that is connected to the first one of the first inputs and whose corresponding diode is connected to the corresponding one of the second nodes connected to the first one of the second inputs by (ii) the current through the resistor connected to a respective one of the first nodes that is connected to the first one of the first inputs, wherein the resistance of the RTS whose first end is connected to the respective one of the first nodes that is connected to the first one of the first inputs and whose corresponding diode is connected to the corresponding one of the second nodes connected to the first one of the second inputs correlates to a temperature measured by the RTS whose first end is connected to the respective one of the first nodes that is connected to the first one of the first inputs and whose corresponding diode is connected to the corresponding one of the second nodes connected to the first one of the second inputs;
(g) repeat (b) through (f) for each subsequent one of the first inputs; and
(h) repeat (a) through (g) for each subsequent ones of the second inputs.

9. The device of claim 8, wherein the first end of each diode comprises an anode and the second end of each diode comprises a cathode.

10. The device of claim 8, wherein each of the first inputs of the device comprises an analog-to-digital controller (ADC) and each of the second inputs of the device comprises a general purpose input.

11. The device of claim 8, wherein each of the RTSs comprise either a negative-temperature-coefficient sensor or a positive-temperature-coefficient sensor.

12. The device of claim 8, wherein the device comprises an analog front end.

13. The device of claim 8, wherein the device comprises a microcontroller.

14. A temperature sensing system, the system comprising:
a plurality of resistive temperature sensors (RTSs) arranged in a plurality of groups, each group comprising a same number of RTSs, each RTS adapted to be positioned adjacent a structure whose temperature is to be determined, wherein, for each group of RTSs, a first end of each RTS in a same group is connected to a respective one of a plurality of first nodes;
a plurality of resistors each having a fixed resistance value, a first end of each of the plurality of resistors is adapted to be connected to a supply voltage and a second end of each of the plurality of resistors is connected to the first node of a respective group of RTSs;
a plurality of diodes arranged in a plurality of groups, each group of diodes corresponding to a respective group of RTSs, each diode having a first end and a second end, the first end of each diode being connected to a respective RTS in a respective group of RTSs, the second end of each diode beings connected to the second end of one respective diode in each other group of diodes via a respective one of a plurality of second nodes; and
a device having a plurality of first inputs and a plurality of second inputs;
wherein each of the first nodes is connected to a respective first input of the device;
wherein each of the second nodes is connected to a respective second input of the device;
wherein a quantity of the resistors equals a quantity of the groups of the RTSs;
wherein a quantity of the first nodes equals a quantity of the groups of the RTSs;
wherein a quantity of the diodes equals a quantity of the RTSs; and
wherein a quantity of the second nodes equal a quantity of the RTSs in each group of the RTSs.

15. The system of claim 14, wherein the device further comprises control circuitry configured to:
(a) set a first one of the second inputs to ground and others of the second inputs to a high resistance mode such that current flows through each RTS connected via a corresponding diode to a corresponding one of the second nodes connected to the first one of the second inputs;
(b) measure a voltage at a first one of the first inputs;
(c) determine a voltage drop across the resistor connected to a respective one of the first nodes that is connected to the first one of the first inputs by subtracting (i) the measured voltage at the first one of the first inputs from (ii) the supply voltage;
(d) determine a current through the resistor connected to a respective one of the first nodes that is connected to the first one of the first inputs by dividing (i) the determined voltage drop across the resistor connected to a respective one of the first nodes that is connected to the first one of the first inputs by (ii) the fixed resistance value of the resistor connected to a respective one of the first nodes that is connected to the first one of the first inputs;
(e) determine a voltage drop across the RTS whose first end is connected to the respective one of the first nodes that is connected to the first one of the first inputs and whose second end is connected to a respective one of the diodes whose second end is connected to the corresponding one of the second nodes connected to the first one of the second inputs by subtracting (i) a voltage drop across the diode whose second end is connected to the corresponding one of the second nodes connected to the first one of the second inputs and whose first end is connected to the RTS which is connected to the one of the first nodes that is connected to the first one of the first inputs from (ii) the measured voltage at the first one of the first inputs;
(f) determine a resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs by dividing the voltage drop across the RTS whose first end is connected to the respective one of the first nodes that is connected to the first one of the first inputs and whose second end is connected to a respective one of the diodes whose second end is connected to the corresponding one of the second nodes connected to the first one of the second inputs by the current through the resistor connected to a respective one of the first nodes that is connected to the first one of the first inputs, wherein the resistance of the RTS whose first end is connected to the respective one of the first nodes that is connected to the first one of the first inputs and whose second end is connected to a respective one of the diodes whose second end is connected to the corresponding one of the second nodes connected to the first one of the second inputs correlates to a temperature measured by the RTS whose first end is connected to the respective one of the first nodes that is connected to the first one of the first inputs and whose second end is connected to a respective one of the diodes whose second end is connected to the corresponding one of the second nodes connected to the first one of the second inputs;
(g) repeat (b) through (f) for each subsequent one of the first inputs; and
(h) repeat (a) through (g) for each subsequent ones of the second inputs.

16. The system of claim 14, wherein the first end of each diode comprises an anode and the second end of each diode comprises a cathode.

17. The system of claim 14, wherein each of the first inputs of the device comprises an analog-to-digital controller (ADC) and each of the second inputs of the device comprises a general purpose input.

18. The system of claim 14, wherein each of the RTSs comprise either a negative-temperature-coefficient sensor or a positive-temperature-coefficient sensor.

19. The system of claim 14, wherein the device comprises an analog front end.

20. The system of claim 14, wherein the device comprises a microcontroller.
